(19) United States
(12) Patent Application Publication
(10) Pub. No.: US 2007/0062361 A1
(43) Pub. Date: Mar. 22, 2007

(54) Chainsaw tensioner

(76) Inventors: Wei Xiong, Guangzhou City (CN); Haijun Zhou, The city zone of Dongguan City (CN); Chin Fai Lo, Tsuen Wan (HK); Andrew Eyre, Kowloon (HK); Roger Smith, Tai Po (HK)

Correspondence Address: BRINKS HOFER GILSON & LIONE, P.O. BOX 10395, CHICAGO, IL, 60610, US

(21) Appl. No.: 11/228,148

(22) Filed: Sep. 16, 2005

(51) Int. Cl. B23D 55/00

(52) U.S. Cl. 83/814

(57) ABSTRACT

A chainsaw tensioner that includes set of bevel gears. The input gear is connected to a knob to be operated to the user. Torque from the input knob is transferred to an output bevel gear that is connected to a threaded rod. A plate travels about the threaded rod and is mated with the chain guide bar. When the rod is rotated, the plate and the chain guide bar translate linearly to either tighten or loosen the chain around the periphery of the chain guide bar depending on the direction of rotation of the knob.

### BACKGROUND OF THE INVENTION

The present invention relates to a chainsaw tensioner for imparting a suitable amount of tension to the chain of a chainsaw.

It is known that over time the chain on a chainsaw loosens. Generally, the chainsaw is provided with an ability to move the chain guide bar and thus, increase the chain tension.

### SUMMARY

According to the present invention, a chain tensioner for a chainsaw chain is provided. In general, the chainsaw contains the elements of a conventional chainsaw, including a shell that forms the majority of the exterior surface of the chainsaw, an internal motor driven by a power source, a gear coupled with the motor, a chain guide bar, and a chain that makes a continuous loop around the periphery of the chain guide bar.

The present invention includes a bevel gear system used to adjust the tension in the chain. One of the bevel gears is attached to an adjustment knob mounted on the chainsaw housing and is the means for the user to adjust chain tension. The second bevel gear is attached to a rod with a threaded section. An adjustment plate contains a tapped hole and rides about the threaded portion of the rod. The adjustment plate contains a protrusion that fits into an aperture in the chain guide bar. The tensioner operates such that when the user rotates the adjustment knob, the gears rotate to cause the adjustment plate to travel along the length of the rod. The chain guide bar will move linearly along with the adjustment plate such that the rotation of the adjustment knob will apply or release tension on the chain as is desired by the user.

### BRIEF DESCRIPTION OF THE DRAWINGS

FIG. 1 is a perspective view of a chainsaw that incorporates one embodiment of the tensioner according to the present invention.

FIG. 2 is a partial exploded view of the chainsaw of FIG. 1 to illustrate the features of the tensioner of the present invention.

FIG. 3 is a portion of a chainsaw with a housing removed to better illustrate a portion of the tensioner according to the present invention.

FIG. 4 is a cross-sectional view of the housing shown in FIG. 3.

FIG. 5 is a cross-sectional view of a portion of the housing.

FIG. 6 shows the drive mechanism of the tensioner according to the present invention.

### DETAILED DESCRIPTION OF THE DRAWINGS AND THE PREFERRED EMBODIMENTS

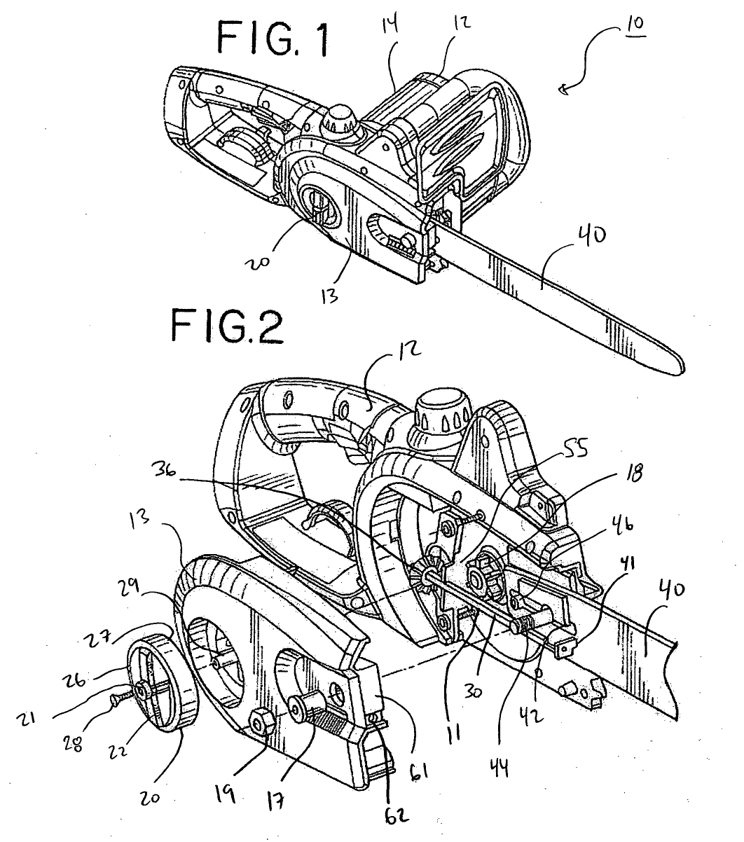

As shown in FIG. 1, a chainsaw 10 incorporating the tensioner according to the present invention is provided. The chainsaw 10 generally contains the elements of a conventional chainsaw. Thus, for example, the chainsaw 10 includes a shell 12 that is typically formed of two pieces, a housing 14, and a cover plate 13, that forms the majority of the exterior surface of the chainsaw 10, and an internal motor (not shown) driven by an external AC power source (not shown). As is known in the art, the power may be supplied from an AC source or a DC source, such as rechargeable batteries. The chainsaw 10 additionally includes a driving gear 18 mechanically coupled to the motor, a chain (not shown) and a chain guide bar 40 upon which the chain rotates. Chain tension is provided by a chain tensioning mechanism 11 featuring a bevel gear system.

Turning now to FIG. 2, the chain tension mechanism 11 is operated by the user with the aid of the adjustment knob 20. The adjustment knob 20 contains an interior surface 27 and an exterior surface 26. The knob 20 extends from a cover plate 13 that is attached to the chainsaw housing 14. The exterior surface 26 of the adjustment knob 20 features a protrusion 22 sized to allow the user to easily grasp and rotate the adjustment knob 20. The protrusion 22 is oriented along a diameter of the adjustment knob 20. The adjustment knob 20 is attached to the cover plate 13 such that the knob 20 is free to rotate but is otherwise fixed to the cover plate 13 with the use of a fastener 28 through a hole 21 in the center of the adjustment knob 20 with the fastener 28 attached to a post 29 formed in the cover plate 13. The axis of rotation of the adjustment knob 20 is orthogonal to a plane formed through the side surface of the chain guide bar 40. The interior surface 27 of the adjustment knob contains input bevel gear teeth 24 (FIG. 6).

The input bevel gear teeth 24 are coupled with an output bevel gear 36. The output bevel gear 36 is attached to a rod 30, such that the rod 30 extends from the axis of rotation of the output bevel gear 36 and such that rotation of the output bevel gear 36 will cause similar rotation of the rod 30. The rod 30 is oriented such that a line through the length of the rod 30 is parallel to a plane formed by a side surface of the chain guide bar 40. A portion of the rod 30 is threaded 32 using standard threading (FIG. 6).

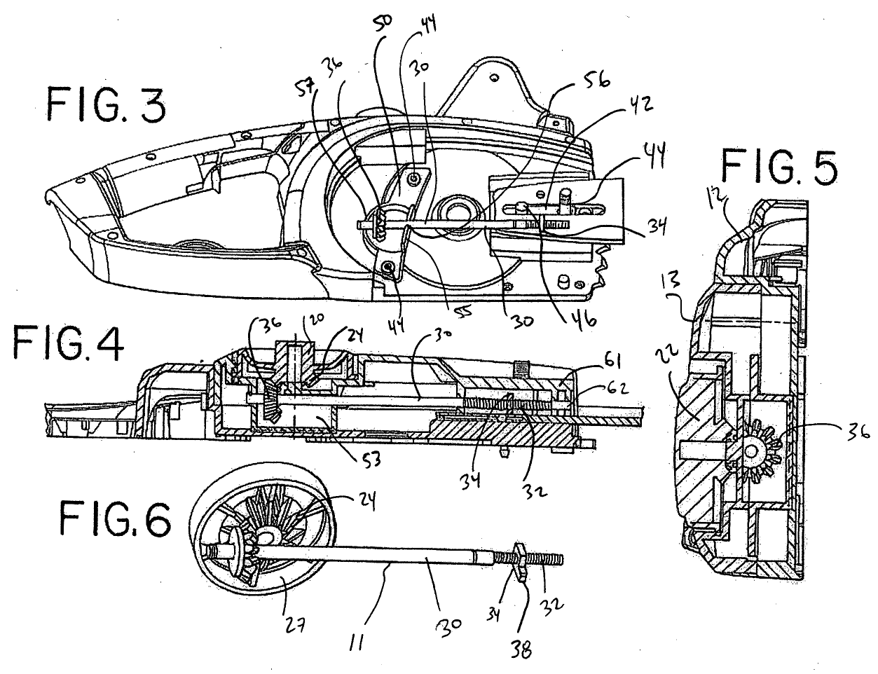

The gears 24, 36 are maintained in the meshed state by the seal housing 50 (FIG. 3), which is attached to the cover plate 13 with screws 44 or other attachment mechanisms known in the art. The seal housing 50 forms a chamber 53 (FIG. 4) within which the bevel gears 24, 36 mesh. As is best seen in FIG. 3, the seal housing 50 also has a wall 55 in front of the output bevel gear 36 that contains a notch 56 to laterally support the adjustment bar 30, and a wall 57 behind the output bevel gear 36 to support the output bevel gear 36. Additionally, the seal housing 50 serves to limit any translational motion of the output bevel gear 36 and the rod 30.

The chain tensioning mechanism 11 also contains an adjustment plate 34 that features a tab 38. The adjustment plate 34 contains a tapped hole (not shown) through which the threaded portion 32 of the adjustment bar 30 is inserted. The tab 38 is inserted into an aperture 41 in the chain guide bar 40. This mechanical connection keeps the adjustment plate 34 in the same orientation during operation of the chain tensioning mechanism 11. Thus, when the adjustment knob 20 is rotated by the user, the output bevel gear 36 will be rotated by the torque applied by the input bevel gear 24. The rotation of the output bevel gear 36 will cause the rod 30 to rotate. This rotation will cause the adjustment plate 34 to move linearly because the adjustment plate 34 is prevented from rotating along with the rod 30 by the mechanical connection with the chain guide bar 40 and the prevention of linear motion of the output bevel gear 36 and rod 30 by the cover plate 13 and the seal housing 50.

If the user rotates the adjustment knob 20 in the clockwise direction (as observed when viewing the adjustment knob 20 straight on, or observing the side of the chainsaw 10 where the chain guide bar 40 extends toward the right) the chain guide bar 40 will be moved axially away from the chainsaw housing 12 and increase the tension on the chain. The clockwise rotation of the adjustment knob 20 will cause counterclockwise motion of the output bevel gear 36 and the rod 30 (as observed from the rear of the chainsaw). Because the output bevel gear 36 is prevented from linear motion with respect to the shell 12 by the seal housing 50, counterclockwise rotation will cause the adjustment plate 34 along with the chain guide bar 40 to translate axial in a direction away from the output bevel gear 36 thereby placing tension on the chain. If the user turns the adjustment knob 20 in a counterclockwise direction, the output bevel gear 36 and the adjustment bar 30 will be rotated in a clockwise direction. Because the output bevel gear 36 and the adjustment bar 30 are prevented from translational motion by the seal housing 50, the motion will be transferred to the adjustment plate 46 and the chain guide bar 40 in a direction towards the rear of the chainsaw 10, thereby removing tension from the chain.

The chain guide bar 40 is restricted from any motion other than the axial motion described above by the guide bar slot 42 formed in the chain guide bar 40. Two projections are inserted into the guide bar slot 42, a post 46 that is rigidly attached to the chainsaw housing 14, and a screw 44 that is rigidly attached to the cover plate 13. The post 46 and the screw 44 prevent any rotational or translational motion of the chain guide bar 40 with respect to the chainsaw shell 12 other than the axial motion caused by the bevel gears and the rod 30. The guide bar slot 42 is sized with a width to allow the guide bar 40 to axially translate with respect to the post 46 and the screw 44, and a length to allow the full range of chain guide bar 40 motion for the chain to be sufficiently tightened and loosened during all modes of operation of the chainsaw 10. The post 46 is either formed as a structural part of the housing 14 or is attached to the housing 14 using any method as is known in the art. The screw 44 is threaded on one end and is rigidly held by the cover plate 13 with an insert 17 and a bolt 19. Additionally, it should be noted that the screw 44 can be rigidly held to the cover plate 13 by any method known in the art.

The cover plate 13 contains sufficient structure to stabilize the rod 30 and therefore the entire chain tensioning mechanism 11 throughout its entire range of motion. As is shown in FIGS. 2 and 4, the cover plate 13 contains at least one projection 61 from the interior surface (not shown) of the cover plate 13. This projection 61 is generally perpendicular to the interior surface of the cover plate 13 and is formed to substantially enclose a portion of the chain tensioning mechanism 11, including the rod 30, the adjustment plate 34, the chain guide bar 40, the guide bar slot 42, the post 46, and the screw 44 to prevent foreign matter from obstructing the operation of these components. The projection 61 contains at least one hole 62 through which the rod 30 is inserted to stabilize the rod 30 but to allow for rotation of the rod 30. Depending on the structure of the projection 61, additional holes 62 may need to be provided to allow the rod clearance and proper rotation.

Of course, it should be understood that a wide range of changes and modifications could be made to the embodiments described above. It is therefore intended that the foregoing detailed description be regarded as illustrative rather than limiting, and that it be understood that it is the following claims, including all equivalents, that are intended to define the spirit and scope of this invention.

What is claimed:

1. A chainsaw tensioner comprising:
a. a chain guide bar;
b. an adjustment plate associated with the chain guide bar;
c. a rod having a first end operatively engaged with the adjustment plate and a second end having a gear; and,
d. a bevel gear engaging the gear such that when the bevel gear is rotated the adjustment plate is moved back and forth in the axial direction of the rod to displace the chain guide bar in the longitudinal direction thereof to adjust the level of tension applied to a chain.

2. The chainsaw tensioner of claim 1 wherein a portion of the adjustment plate engages an aperture provided on the chain guide bar.

3. The chainsaw tensioner of claim 1 wherein the first end of the rod has threads to engage threads provided in the adjustment plate.

4. The chainsaw tensioner of claim 1 further comprising a cover plate adapted to receive a portion of the first end of the rod.

5. The chainsaw tensioner of claim 4 wherein a portion of the bevel gear includes a knob that extends from the cover plate.

6. A chainsaw tensioner comprising:
a. a housing having a first portion and a second portion;
b. a chain guide bar longitudinally extending from the housing;
c. an adjustment plate associated with the chain guide bar;
d. a rod having a first end operatively engaged with the adjustment plate and a second end having a gear; and,
e. a knob having a first portion extending from a face of the first portion of the housing and having a second portion defining a bevel gear engaging the gear such that when the knob is rotated the chain guide bar is displaced in the longitudinal direction thereof to adjust the level of tension applied to a chain.

7. The chainsaw tensioner of claim 6 wherein a portion of the adjustment plate engages an aperture provided on the chain guide bar.

8. The chainsaw tensioner of claim 6 wherein the first end has threads to engage threads provided in the adjustment plate.

9. The chainsaw tensioner of claim 6 further comprising a seal housing surrounding the bevel gear and the rod gear.

10. The chainsaw tensioner of claim 6 wherein the first portion of the housing further includes a channel adapted to receive the first end of the rod.
